(19) United States
(12) Patent Application Publication
(10) Pub. No.: US 2006/0146404 A1
(43) Pub. Date: Jul. 6, 2006

(54) Image display system

(76) Inventors: Sadao Ioki, Gunma (JP); Sanji Arisawa, Niigata (JP); Seijiro Tomita, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/545,948

(22) PCT Filed: Feb. 2, 2004
(86) PCT No.: PCT/JP04/01022

§ 371 Date: Aug. 17, 2005

(30) Foreign Application Priority Data
Feb. 19, 2003 (JP) 2003-41530

(51) Int. Cl. G02B 27/28

(52) U.S. Cl. 359/485

(57) ABSTRACT

The present invention is intended to reduce cross-talk and obtain a wide viewing angle. The invention provides an image display system including: a filter including a first area which transmits a light having a specific polarization and a second area which transmits a light having a polarization orthogonal to the light having the specific polarization provided repeatedly in the vertical direction, and a light source (201) including a light-emitting source (210), polarizing means (212) for turning the light as the light having the specific polarization and the light having the polarization in which the polarization axis is orthogonal to the polarization axis of the specific polarization to output the lights, and optical means (203) for refracting lights having different polarities into direction which is routed to left and right eyes respectively and irradiating the same on a liquid crystal display panel (205), wherein the light-emitting source (210) is a linear light-emitting source having a light source member for displaying three-dimensional images at a center portion thereof and a light source member for enlarging the viewing angle at the both ends thereof, and the linear light-emitting source is disposed laterally with respect to the liquid crystal display panel (205) and the linear light-emitting source is formed into the shape of a curved line so that light-emitting portions are positioned at substantially the same distance from the center portion of the optical means (203).

### FIELD OF THE INVENTION

The present invention relates to an image display system and, more specifically, to a three-dimensional image display system in which a viewer can view a three-dimensional image without wearing specific eye-glasses.

### DESCRIPTION OF THE RELATED ART

Hitherto, a three-dimensional image display system has a configuration such that a polarizing filter part for the right eye and a polarizing filter part for the left eye having the polarization directions intersecting orthogonally with each other are arranged on the left and right of the front surface of a light source, the respective light rays past respective polarizing filter parts are made into parallel beams by a Fresnel lens, and irradiated on a liquid crystal display device, each linear polarizing filter line of the polarizing filters on either side of the liquid crystal device has a polarization direction orthogonal to both polarization directions of an adjacent filter line, and corresponding polarizing filter line of the other side polarizing filter, whereby the video information for the right eye and the left eye is alternately displayed by each of the one horizontal line in compliance with the light transmission lines of the two polarizing filters on liquid crystal panels of the liquid crystal display devices. Also, the polarization filter on the light source side is adapted to have the linear polarizing filter line parts being respectively intersected orthogonally with each other at every one horizontal line and being alternately arranged, and the polarization filter on the observation side is adapted to be a linear polarization filter which has one of the linear polarizing filter line parts on the polarizing filter on the light source side, whereby the video information for the right eye and the left eye is alternately displayed by each of the one horizontal line in compliance with the light transmission lines of the polarizing filters on the light source side on the liquid crystal panels of the liquid crystal display devices (for example, Patent Document 1).

[Patent Document 1]

JP-A-10-63199

However, in the image display system in the related art as described above, even though the light rays from the light source are made into parallel beams for left eye and parallel beams for right eye by the Fresnel lens, cross-talk which is overlapped of these light beams, and hence there arises a problem that the three-dimensional image cannot be recognized easily due to the cross-talk. There is also a problem that the left and right angles of visibility are narrow.

### DISCLOSURE OF THE INVENTION

An object of the invention is to provide an image display system which can facilitate recognition of a three-dimensional image by reducing cross-talk, and can widen the left and right angles of visibility.

A first aspect of the invention is an image display system including a liquid crystal display panel which can transmit a light irradiated from behind, a light source for irradiating a light having a specific polarization and a light having a polarization orthogonal to the specific polarization onto the liquid crystal display panel; and a filter disposed between the liquid crystal display panel and the light source and having a first area for transmitting the light having the specific polarization and a second area for transmitting the light having the polarization orthogonal to the light having the specific polarization provided repeatedly in the vertical direction, the light source includes a light-emitting source for emitting a light having unspecific polarization, polarizing means for turning the light having unspecific polarization into the form of the light having the specific polarization and the light having the polarization in which the polarization axis is orthogonal to the polarization axis of the specific polarization to output the lights, and optical means for refracting lights having different polarizations into the directions which is routed to left and right eyes respectively and irradiating the same on the liquid crystal display panel, wherein the light-emitting source is a linear light-emitting source for emitting light linearly, having a light source member for displaying three-dimensional images at a center portion thereof and light source members for enlarging the viewing angle at the both ends thereof, and the linear light-emitting source is disposed laterally with respect to the liquid crystal display panel and the linear light-emitting source is formed into the shape of a curved line so that light-emitting portions are positioned at substantially the same distance from a center portion of the optical means.

A second aspect of the invention is an image display system including a liquid crystal display panel which can transmit a light irradiated from behind, a light source for irradiating a light having a specific polarization and a light having a polarization orthogonal to the specific polarization onto the liquid crystal display panel; and a filter disposed between the liquid crystal display panel and the light source and having a first area for transmitting the light having the specific polarization and a second area for transmitting the light having the polarization orthogonal to the light having the specific polarization provided repeatedly in the vertical direction, the light source includes a light-emitting source for emitting a light having unspecific polarization, polarizing means for turning the light having unspecific polarization into the form of the light having the specific polarization and the light having the polarization in which the polarization axis is orthogonal to the polarization axis of the specific polarization to output the lights, and optical means for refracting lights having different polarizations into the directions which is routed to left and right eyes respectively and irradiating the same on the liquid crystal display panel, wherein the light-emitting source is a linear light-emitting source for emitting light linearly, having a light source member for displaying three-dimensional images at a center portion thereof and light source members for enlarging the viewing angle at the both ends thereof, and the linear light-emitting source is disposed laterally with respect to the liquid crystal display panel and the linear light-emitting source is formed into a polygonal line so that light-emitting portions are positioned at substantially the same distance from a center portion of the optical means.

In the first aspect of the invention, a third aspect of the invention is characterized in that the linear light-emitting source has an arcuate shape centered on the center portion of the optical means.

In the second aspect of the invention, a fourth aspect of the invention is characterized in that the linear light-emitting source is formed in a shape of a symmetrical polygonal line having the linear light source member for displaying three-dimensional images extending in parallel with the display surface of the liquid crystal display panel at the center portion thereof, and the light source members forming an angle with respect to the display surface of the liquid crystal display panel for widening the lateral viewing angle at both ends thereof.

In the second or fourth aspects of the invention, a fifth aspect of the invention is characterized in that the linear light-emitting source in the shape of the polygonal line includes a plurality of units of the straight linear light-emitting sources disposed in the shape of the polygonal line.

In the first to fifth aspects of the invention, a sixth aspect of the invention is characterized in that the linear light-emitting source includes a plurality of point-like light-emitting sources disposed linearly.

In the sixth aspect of the invention, a seventh aspect of the invention is characterized in that the plurality of point-like light-emitting sources include optical path correcting means for causing the centers of the optical axes pass through the respective center portion of the optical means between the point-like light-emitting sources and the polarizing means.

According to the first and second aspects of the invention, since the linear light-emitting source including the light source member for displaying three-dimensional images at the center portion and the light source members for widening the viewing angle at both ends thereof and emitting lights linearly is used, the large light amount is secured in comparison with the point-like light sources, and hence brightness of the display screen is increased. Also, since the respective light-emitting portions are positioned at a substantially equal distance from the center portion of the optical means even with this structure, cross-stroke which is leakage of lights directed to the left and right eyes respectively from one to another is reduced. Since the linear light-emitting source is formed into the shape of the curved line or the polygonal line, the compact light source is achieved even when a wide viewing angle is secured.

According to the third aspect of the invention, the effect of the first aspect of the invention is effectively achieved.

According to the fourth aspect of the invention, the effect of the second aspect of the invention is achieved with a simplified assembling structure of the light source.

According to the fifth aspect of the invention, since disposition of unit is replaced by bending work of the light source, reduction of workload in manufacturing process is achieved.

According to the sixth aspect of the invention, high flexibility in shape of the linear light-emitting source is achieved.

According to the seventh aspect of the invention, the light from the light source can be emitted adequately to the optical means.

### BRIEF DESCRIPTION OF THE DRAWINGS

FIG. 1 is an explanatory drawing illustrating a function of an image display system according to an embodiment of the present invention.

FIG. 2 is a perspective view of the image display system.

FIG. 3 is an exploded perspective view of the image display system.

FIG. 4 is a block diagram of a drive circuit of the image display system.

FIG. 5 is a front view of a light source body unit.

FIG. 6 is a side view of the light source body unit.

FIG. 7 is an exploded perspective view of the light source body unit.

FIG. 8 is a cross-sectional view of the light source body unit.

FIG. 9 is a perspective view of a polarizing filter.

FIG. 10 is a side view of an optical system of the image display system.

FIG. 11 is a plan view of the optical system of the image display system.

FIG. 12 is a front view of the light source body unit of a second embodiment.

FIG. 13 is a side view of the light source body unit.

FIG. 14 is an exploded perspective view of the light source body unit.

FIG. 15 is a front view of the light source body unit according to a third embodiment.

FIG. 16 is a perspective view of the light source body unit.

FIG. 17 is an exploded perspective view of the light source body unit.

### BEST MODE FOR CARRYING OUT THE INVENTION

Referring now to the drawings, an embodiment of the present invention will be described.

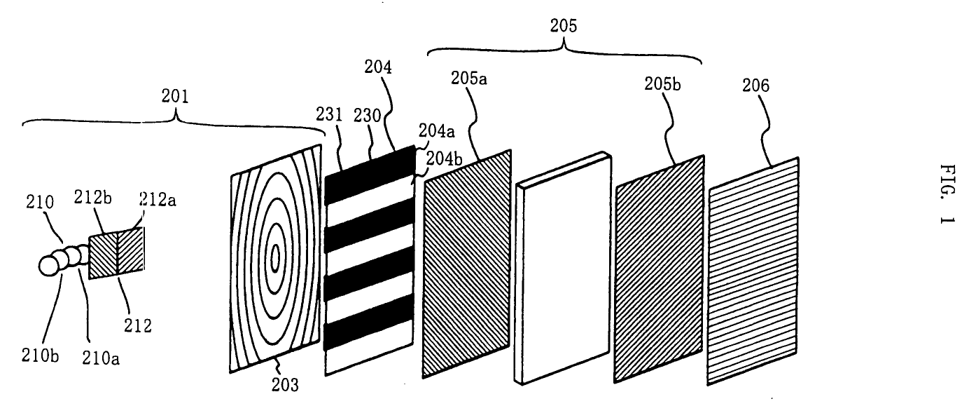

FIG. 1 is an explanatory drawing illustrating a function of an image display system according to an embodiment of the present invention.

A light source 201 includes a light-emitting source 210, a polarizing filter 212 (polarizing means), and a Fresnel lens 203 (optical means). The light-emitting source 210 used here includes white light-emitting diodes or the like (or cold cathode tubes or the like) disposed in the lateral direction. The polarizing filter 212 includes a right area 212a and a left area 212b which are set to provide different polarizations of transmitting lights (for example, to differentiate polarization of transmitting lights between the right area 212a and the left area 212b by 90 degrees). The Fresnel lens 203 has a lens surface having projections and depression concentrically on one side.

Only part of a light emitted from the light-emitting source 210 having predetermined polarizations can be transmitted through the polarizing filter 212. In other words, among lights emitted from the light emitting source 210, a light passed through the right area 212a of the polarizing filter 212 and a light passed through the left area 212b thereof are irradiated on the Fresnel lens 203 as lights having different polarizations. As will be described later, the light passed through the right area 212a of the polarizing filter 212 reaches the left eye of a viewer, and the light passed through the left area 212b reaches the right eye of the viewer.

The lights transmitted through the polarizing filter 212 are irradiated on the Fresnel lens 203. The Fresnel lens 203 is a convex lens, and refracts an optical path of the light emitted from the light-emitting source 210 in a diffusing manner into substantially parallel lights, then allows the same to pass through a micro-patterned retarder 204 and then to be irradiated onto a liquid crystal display panel 205.

At this time, a light irradiated from the micro-patterned retarder 204 is emitted so as not to diffuse in the vertical direction, and is irradiated on the liquid crystal display panel 205. In other words, the light transmitted through a specific area of the micro-patterned retarder 204 is transmitted through a portion of the liquid crystal display panel 205 having a specific unit of display.

Regarding lights irradiated to the liquid crystal display panel 205, the light passed through the right area 212a of the polarizing filter 212 and the light passed through the left area 212b thereof are incident onto the Fresnel lens 203 at different angles, are refracted in the Fresnel lens 203, and are emitted from the liquid crystal display panel 205 along different routes on the right side and the left side.

The liquid crystal display panel 205 is provided with liquid crystal oriented so as to be twisted at a predetermined angle (for example, 90 degrees) between two transparent plates (for example, glass plates), and constitutes, for example, a TFT type liquid crystal display panel. The incident light which is incident upon the liquid crystal display panel is emitted at a polarization shifted by 90 degrees in a state in which no voltage is applied to the liquid crystal. On the other hand, when a voltage is applied to the liquid crystal, twisting of the liquid crystal is released, and the incident light is emitted at the unchanged polarization.

The micro-patterned retarder 204 and a polarizing plate 205a (second polarizing plate) are disposed on the side of the light source 201 of the liquid crystal display panel 205 (a combination of the micro-patterned retarder 204 and the polarizing plate 205a (second polarizing plate) is referred to as a filter), and a polarizing plate 205b (first polarizing plate) is disposed on the viewer side.

The micro-patterned retarder 204 includes areas which change the phase of light ray transmitting therethrough disposed at fine intervals repeatedly. More specifically, a light transmitting base material 230 is formed with areas 204a each provided with a ½ wave plate 231 of a minute width; and areas 204b each having the same interval as the width of the ½ wave plate 231 and not including the ½ wave plate 231 arranged at minute intervals repeatedly. In other words, the areas 204a which change the phase of light ray transmitting therethrough by the ½ wave plates 231 provided and the areas 204b which do not change the phase of light ray transmitting therethrough since the ½ wave plates 231 are not provided are arranged repeatedly at minute intervals. The ½ wave plates 231 function as the retarder plates which change the phase of light ray transmitting therethrough.

The ½ wave plate 231 is disposed so that the optical axis thereof is inclined by 45 degrees with respect to a polarization axis of the light transmitting through the right area 212a of the polarizing filter 212, thereby emitting the light transmitted through the right area 212a with its polarization axis rotated by 90 degrees. In other words, polarization of the light transmitted through the right area 212a is rotated by 90 degrees to equalize to that of the light transmitting through the left area 212b. In other words, the areas 204b where the ½ wave plates 231 are not provided allow lights passed through the left area 212b and having the same polarization as the polarizing plate 205a to be transmitted therethrough. The areas 204a where the ½ wave plates 231 are provided cause the light passed through the right area 212a and having the polarization axis orthogonal to the polarizing plate 205a to be rotated so as to equalize the polarization axis thereof to that of the polarizing plate 205a before emission.

Repetition of the polarization characteristics of the micro-patterned retarder 204 is adapted to have substantially the same pitch as the unit of display of the liquid crystal display panel 205 to differentiate polarization of the lights transmitted therethrough by each unit of display (that is, by each lateral horizontal line of the unit of display). Therefore, the polarization characteristics of the micro-patterned retarder are differentiated for each of corresponding horizontal lines (scanning line) as the unit of display of the liquid crystal display panel 205, whereby the directions of lights emitted from the respective horizontal lines are different.

Alternatively, repetition of the polarization characteristics of the micro-patterned retarder 204 may have a pitch which is integral multiple of the pitch of the unit of display of the liquid crystal display panel 205, so that the polarization characteristics are differentiated for each set of a plurality of units of display on the micro-patterned retarder 204 (that is, for each set of the plurality of horizontal lines as the unit of display), thereby differentiating the polarization of the lights transmitted therethrough for each set of the plurality of units of display. In this case, the polarization characteristics of the micro-patterned retarder are different for each set of the plurality of horizontal lines as the unit of display (scanning lines) of the liquid crystal display panel 205, and hence the directions of the emitted lights are different for each set of the plurality of horizontal lines.

In this manner, since it is necessary to irradiate different lights onto the display devices of the liquid crystal display panel 205 (horizontal lines) for each repeated polarization characteristics of the micro-patterned retarder, the lights to be irradiated on the liquid crystal display panel 205 after having transmitted through the micro-patterned retarder 204 must be vertical diffusion controlled lights.

In other words, the areas 204a of the micro-patterned retarder 204 for changing the phase of the light equalize the light having transmitted through the right area 212a of the polarizing filter 212 with polarization of lights having transmitted through the left area 212b upon transmission. On the other hand, the areas 204b of the micro-patterned retarder 204 which do not change the phase of the light allow the light having transmitted through the left area 212b of the polarizing filter 212 to be transmitted as is. Then, the lights emitted from the micro-patterned retarder 204, having the same polarizations as the light transmitted through the left area 212b, are incident upon the polarizing plate 205a provided on the light source side of the liquid crystal display panel 205.

The polarizing plate 205a functions as the second polarizing plate, and has such polarization characteristics as to allow the light having the same polarization as the light having transmitted through the micro-patterned retarder 204 to be transmitted. In other words, the light having transmitted through the left area 212b of the polarizing filter 212 is transmitted through the second polarizing plate 205a, and the polarizing axis of the light having transmitted through the right area 212a of the polarizing filter 212 is rotated by 90 degrees before being transmitted through the second polarizing plate 205a. The polarizing plate 205b functions as the first polarizing plate, and has such polarizing characteristics as to allow light having a polarization different from the polarizing plate 205a by 90 degrees to be transmitted therethrough.

The micro-patterned retarder 204, the polarizing plate 205a, and the polarizing plate 205b are bonded together to the liquid crystal display panel 205, and the micro-patterned retarder 204, the polarizing plate 205a, the liquid crystal display panel 205, and the polarizing plate 205b are combined to constitute the image display system. At this time, in a state in which a voltage is applied to the liquid crystal, the light having transmitted through the micro-patterned retarder 204 is transmitted through the polarizing plate 205b. On the other hand, in a state in which no voltage is applied to the liquid crystal, the light having transmitted through the micro-patterned retarder 204, whereof the polarization is twisted by 90 degrees, is emitted from the liquid crystal display panel 205, and hence is not transmitted through the polarizing plate 205b.

A diffuser 206 is mounted to the front side (viewer side) of the first polarizing plate 205b, and functions as diffusing means for diffusing the light having transmitted through the liquid crystal display panel in the vertical direction. More specifically, it diffuses light having transmitted through the liquid crystal display panel in the vertical direction using a lenticular lens having projections and depression of semicircular shape in cross-section provided repeatedly in the vertical direction.

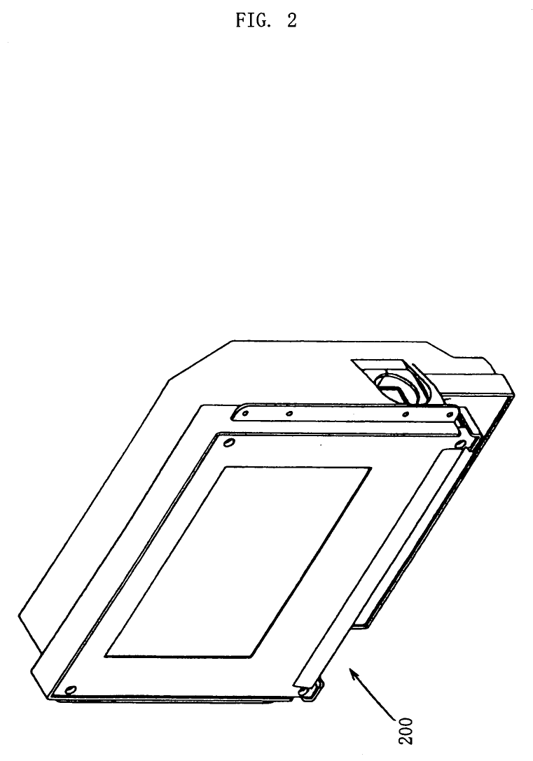

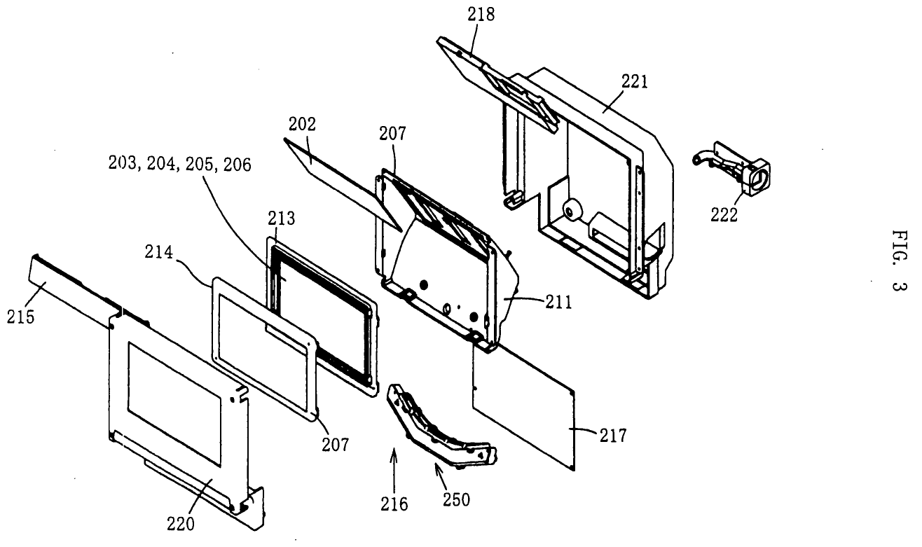

FIG. 2 and FIG. 3 are a perspective view and an exploded perspective view of the image display system according to the embodiment of the present invention.

An image display system 200 includes a light source body unit 250 having the light-emitting source (linear light-emitting source) 210 disposed in a holder 208 of a predetermined shape, a reflecting plate (mirror) 202, the Fresnel lens 203, the micro-patterned retarder 204, the liquid crystal display panel 205, the diffuser 206 and the like are assembled to a case 207.

The light source body unit 250 is mounted to a lower wall of a light source body storage 211 of the case 207 in a rearwardly tilted state so that the linear light-emitting source 210 is disposed in the lateral direction with respect to the liquid crystal display panel 205.

The reflecting plate 202 is mounted to an upper half wall of the light source body storage 211 in an upwardly tilted state so that the light from the linear light-emitting source 210 is irradiated on the Fresnel lens 203.

The linear light-emitting source 210 is disposed in such a manner that the linear light-emitting portions are positioned at substantially equal distance from a center portion of the Fresnel lens 203 via the light source main body unit 250, and are positioned at substantially the same distance as the focal distance thereof (light from the linear light-emitting source 210 and the distance from the center portion of the Fresnel lens 203 are to pass through the reflecting plate 202).

The polarizing filter 212, which converts a light from a right light-emitting portion 210a of the linear light-emitting source 210 into a light having a polarization for the left eye, and a light from a left light-emitting portion 210b of the same to a light having a polarization for the right eye, is mounted to the front surface of the light source body unit 250 as will be described later.

The Fresnel lens 203, the micro-patterned retarder 204, the liquid crystal display panel 205, and the diffuser 206 are fitted to a panel frame 213 and a cover frame 214 of the case 207, and the panel frame 213 and the cover frame 214 are fixedly assembled to the light source body storage 211. A light source body cover 215 is assembled to the light source body storage 211 at the lower portion of the panel frame 213.

A front cover 220 is mounted to the front surface of a display unit 216, and a driving substrate is disposed in substrate holders 217, 218 at the rear portion thereof, and a cover case 221 is mounted. Reference numeral 222 designates an air-cooling fan for the linear light-emitting source 210.

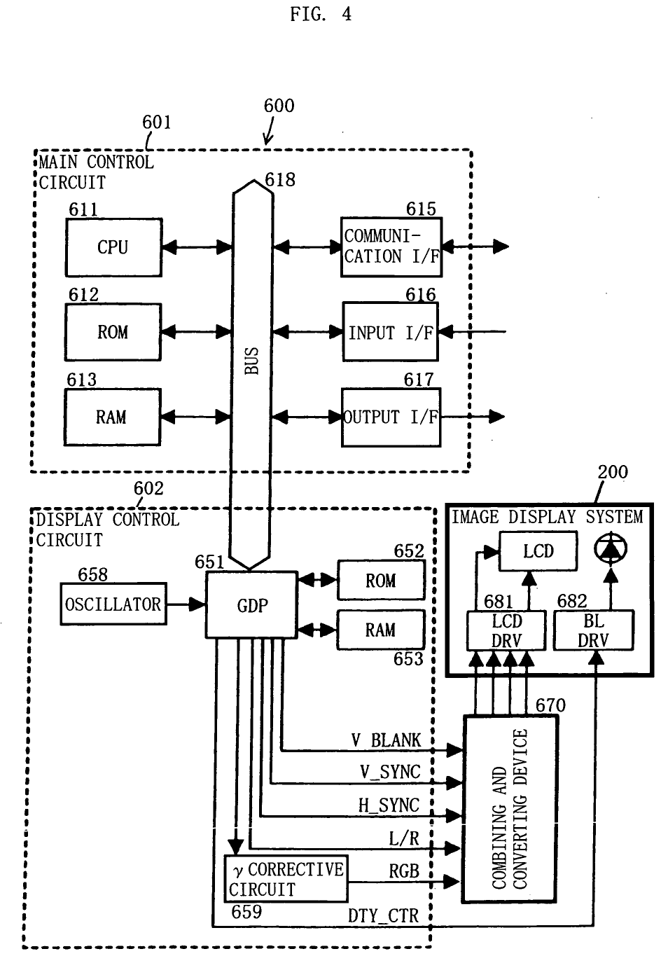

FIG. 4 is a block diagram showing a drive circuit 600 of the image display system 200.

A main control circuit 601 for driving the image display system includes a CPU 611, a ROM 612 having a program or the like stored therein in advance, and a RAM 613 as a memory used as a work area when the CPU 611 is in operation. The CPU 611, the ROM 612, and the RAM 613 are connected by a bus 618. The bus 618 includes an address bus and a data bus which are used when the CPU 611 reads and writes data.

A communication interface 615, an input interface 616, and an output interface 617, which perform input and output with respect to the outside, are connected to the buss 618. The communication interface 615 is a data input/output section for data transmission according to a predetermined communication protocol. The input interface 616 and the output interface 617 input/output image data to be displayed on the image display system.

A graphic display processor (GDP) 651 of a display control circuit 602 is connected to the bus 618. The GDP 651 calculates image data generated by the CPU 611, writes the same to a frame buffer provided in a RAM 653, and generates signals (RGB, V BLANK, V_SYNC, H_SYNC) to be outputted to the image display system. A ROM 652 and the RAM 653 are connected to the GDP 651, and the RAM 653 is provided with a work area where the GDP 651 works and the frame buffer for storing the display data. The ROM 652 includes a program and data required for the operation of the GDP 651.

The GDP 651 includes an oscillator 658 for supplying a clock signal to the GDP 651 connected thereto. The clock signal for generating the oscillator 658 defines the operating frequency of the GDP 651 and generates a frequency of the synchronized signal outputted from the GDP 651 (for example, V_SYNC, VBLAMNK).

The RGB signal output from the GDP 651 is inputted to a γ corrective circuit 659. The γ corrective circuit 659 corrects a non-linear characteristic of brightness with respect to the signal voltage of the image display system, adjusts the illumination brightness of the image display system, and generates the RGB signal output to the image display system.

A combining and converting device 670 is provided with a frame buffer for right-eye, a frame buffer for left-eye and a frame buffer for three-dimensional view, and writes a right-eye image sent from the GDP 651 in the frame buffer for right-eye, a left-eye image to the frame buffer for left-eye. Then, the combining and converting device combines the right-eye image and the left-eye image to generate an image for three-dimensional view, and writes the same in the frame buffer for three-dimensional view, and outputs the image date for three-dimensional view to the image display system as the RGB signal.

Generation of the image for three-dimensional view by combining the right-eye image and the left-eye image is done by combining the right-eye image and the left-eye image according to the intervals of the ½ wave plates 231 of the micro-patterned retarder 204. More specifically, since the ½ wave plates 231 of the micro-patterned retarder 204 of the image display system according to the present embodiment are disposed at intervals of the unit of display of the liquid crystal display panel 205, the image for three-dimensional view is displayed so that the right-eye images and the left-eye images are alternately displayed by each lateral line (scanning line) as the unit of display of the liquid crystal display panel 205.

The left-eye image data transmitted from the GDP 651 during output of a L signal is written in the frame buffer for left-eye and the right-eye image data transmitted from the GDP 651 during output of a R signal is written in the frame buffer for right-eye. Then, the left-eye image data written in the frame buffer for left-eye and the right-eye image data written in the frame buffer for right-eye are read out for each scanning line and written in the frame buffer for three-dimensional view.

The image display system includes a liquid crystal driver (LCD DRV) 681, and a backlight driver (BL DRV) 682. The liquid crystal driver (LCD DRV) 681 applies a voltage to the electrodes of the liquid crystal display panel in sequence based on the V BLANK signal, the V_SYNC signal, H_SYNC signal, and the RGB signal transmitted from the combining and converting device 670 to display a combined image for three-dimensional view on the liquid crystal display panel.

The backlight driver 682 changes duty ratios of voltage applied to the backlight (light-emitting source 210) based on the DTY_CTR signal output from the GDP 651, thereby changing brightness of the liquid crystal display panel 205.

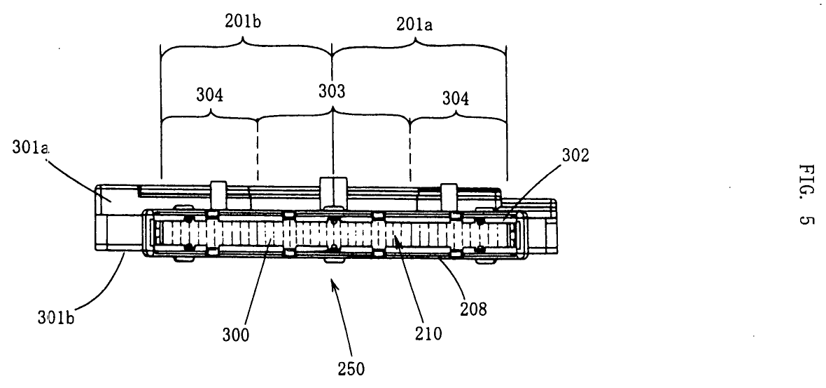

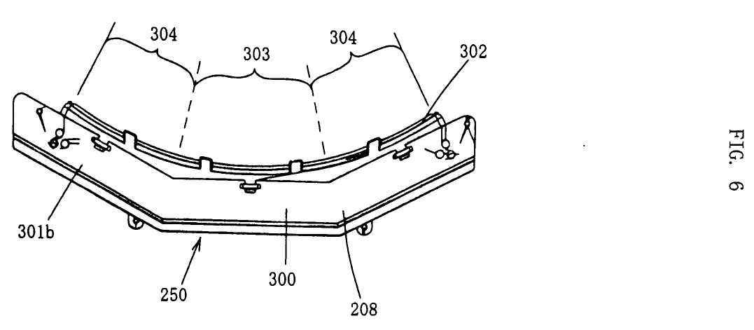

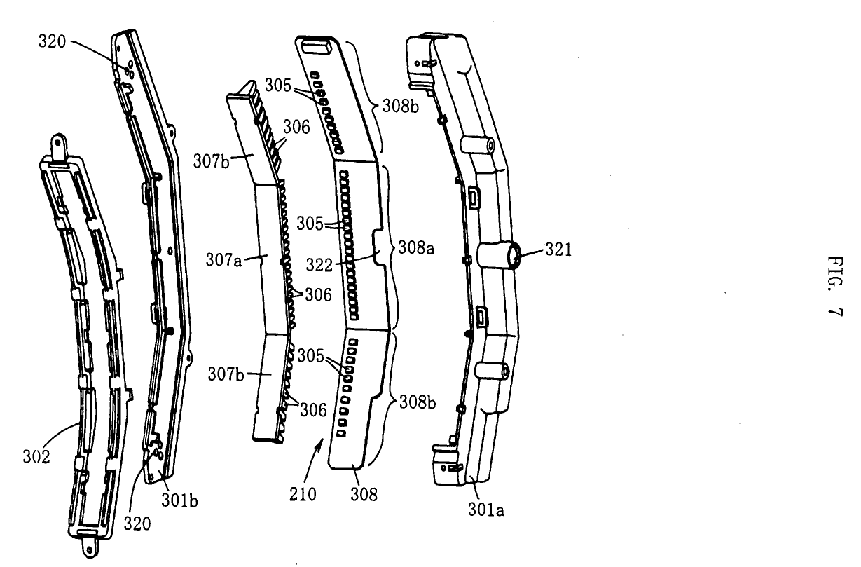

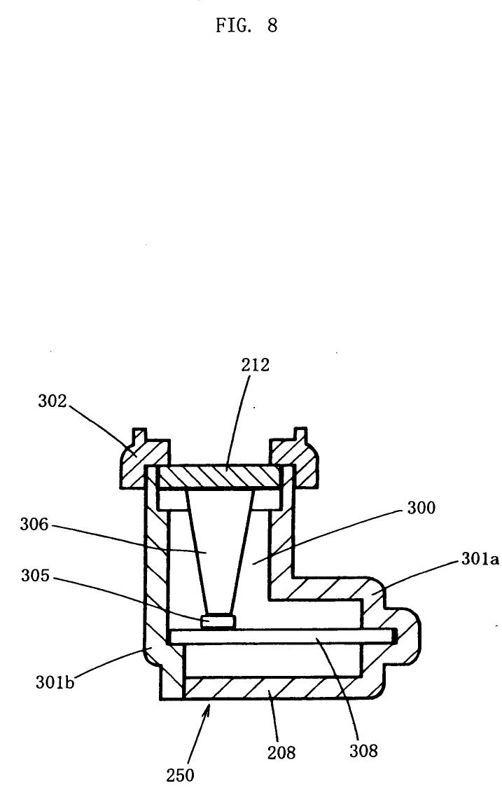

FIG. 5 to FIG. 8 are a plan view, a side view, an exploded perspective view, and a cross-sectional view of the light source body unit 250. The linear light-emitting source 210 is formed of a plurality of point-like light-emitting sources arranged linearly (LEDs (light-emitting diodes): white light-emitting diode or the like) or an elongated cold cathode tube or the like, and in this embodiment, the case in which the point-like light-emitting sources are used will be described.

The holder 208 includes storage cases 301a, 301b and a cover 302 of separate members which form a storage 300 in the shape of the polygonal line. The storage 300 includes a center portion 303 of a predetermined length, and peripheral portions 304 disposed at both ends thereof and bent at predetermined angles toward the front of the holder.

The linear light-emitting source 210 includes a predetermined number of LEDs (light-emitting diode: white light-emitting diode or the like) 305 linearly arranged on and attached to a center portion 308a of the substrate 308 of a predetermined length, and peripheral portions 308b located at both sides thereof and inclined at a predetermined angle toward the front of the substrate.

Prisms 306 (optical path correcting means) for preventing diffusion of lights of the LEDs 305 and causing the lights to be emitted at a predetermined angle so that the centers of the optical axes pass the center portion of the Fresnel lens 203 are provided on the front surfaces of the LEDs 305. The prisms 306 are formed integrally with a center prism body 307a and peripheral prism bodies 307b corresponding to the LEDs 305 on the center portion 308a and the LEDs 305 on the peripheral portions 308b.

A substrate 308 with the LEDs 305 arranged thereon is stored in the storage cases 301a, 301b of the holder 208, the center prism body 307a and the peripheral prism bodies 307b are aligned with and assembled to the LEDs 305 of the center portion 308a and the LEDs 305 on the peripheral portions 308b respectively, and the polarizing filter 212 is mounted to the front surface of the respective prism bodies 307a, 307b via the cover 302, so that a light source body unit 250 is formed.

The linear light-emitting source 210 employs the LEDs 305 on the center portion 308a of the substrate 308 as the light source member for displaying three-dimensional images, which extends linearly in parallel with the display surface of the liquid crystal display panel 205, and the LEDs 305 of the peripheral portion 308b of the substrate 308 as the light source member having an angle with respect to the display surface of the liquid crystal display panel 205 for widening the angles of visibility for widening the lateral viewing angle, and is formed into the shape of symmetrical polygonal line.

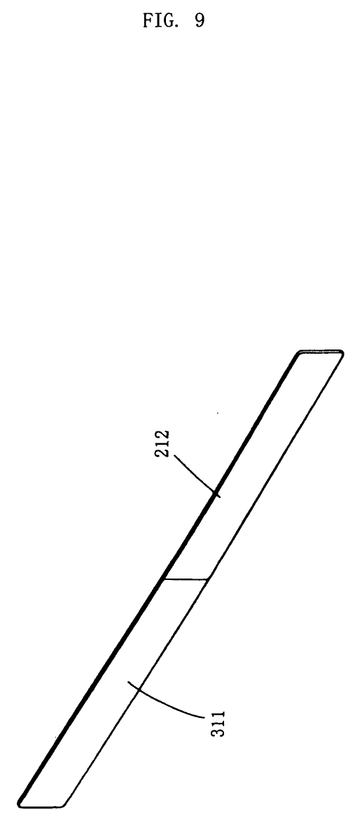

The polarizing filter 212 has different characteristics between the right light-emitting portions 210a of the linear light-emitting source 210 and the left light-emitting portions 210b thereof bounded by a center of the linear light-emitting source 210 as shown in FIG. 5. Therefore, when it is difficult to form the boundary between the left and right light-emitting portions 210a, 210b, it is possible to mount the same polarizing filters 212 to the front surfaces of the left and right light-emitting portions 210a, 210b (front surface of the prism bodies 307a, 307b) as shown in FIG. 9, and bond a predetermined wave plate 311 on one of them. Although the linear light-emitting source 210 is formed into a single substrate, it is also possible to divide the substrate into a substrate of the linear center portion 308a, and substrates of the linear peripheral portions 308b, linearly arrange the LEDs 305 on the respective substrates as units, dispose the units of the plurality of linear light-emitting source of the linear shape into the shape of a polygonal line to form the linear light-emitting source 210.

In FIG. 5 to FIG. 7, the storage cases 301a, 301b of the holder 208 are formed with an inlet port 320 and an exhaust port 321 for air-cooling. Since the substrate 308 is formed of an aluminum substrate having a large surface area for ensuring good heat radiating property. By driving the air-cooling fan 222 (see FIG. 3), air sucked from the inlet port 320 flows from the peripheral portion 308b to the center portion 308a along the both surfaces of the substrate 308, and is discharged from the exhaust port 321. The center portion 308a of the substrate 308 is formed with a notch 322 at which air flowing on the both surfaces of the substrate 308 are combined on the periphery of the exhaust port 321 of the entrance for improving exhaust efficiency. Therefore, the linear light-emitting source 210 can be cooled efficiently and adequately.

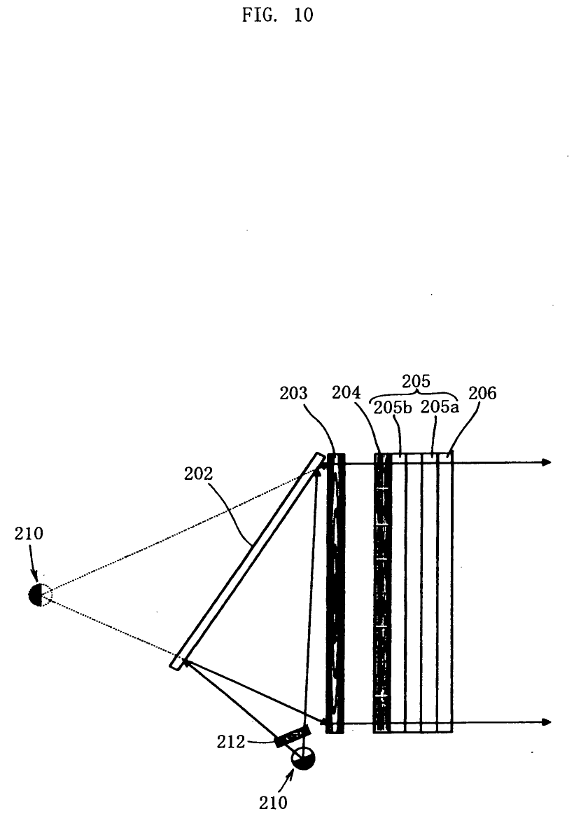

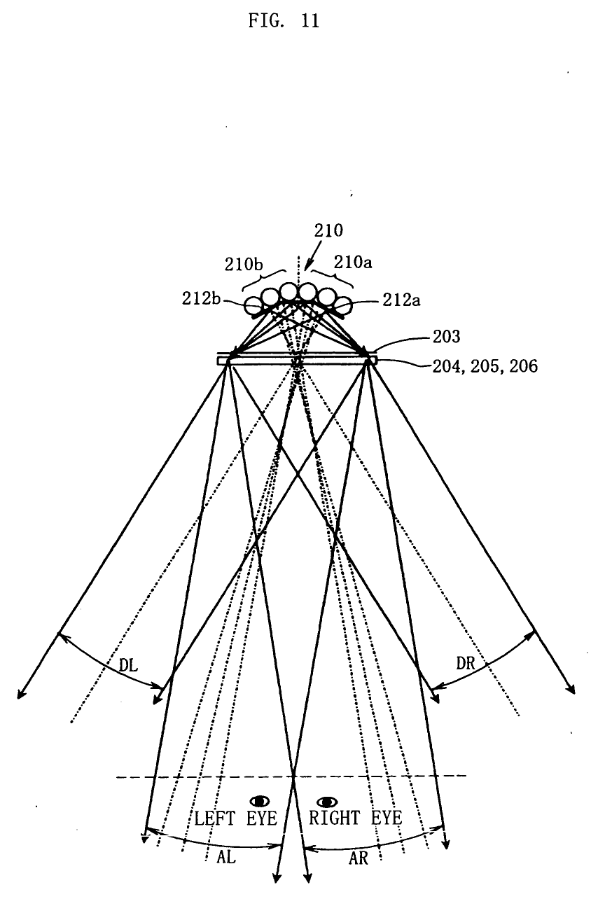

FIG. 10 and FIG. 11 are a side view and a plan view showing an optical system of the image display system 200. However, the linear light-emitting source 210 displayed in FIG. 10 is only the center portion, and the linear light-emitting source 210 shown by a dotted line is an apparent position. In FIG. 11, the reflecting plate 202 and the prism bodies are omitted, and the linear light-emitting source 210 is illustrated at the apparent position and the left and right light-emitting portions 210a, 210b are illustrated schematically.

The left and right light-emitting portions 210a, 210b of the light-emitting source 210 will be described below as individual light-emitting points.

As shown in FIG. 11, lights emitted from the respective light-emitting portions 210a, 210b are passed through the polarizing filter 212 and is radially diffused. Part of the lights emitted from the right light-emitting portions 210a which have passed through the right area 212a of the polarizing filter 212 (a dashed line indicates a center of the optical path) reach the Fresnel lens 203, where the directions of travel of the lights are changed, then are transmitted through the micro-patterned retarder 204 and the liquid crystal display panel 205, and then reach the left eye zone.

Since the right light-emitting portions 210a are arranged consecutively on the center portion (right side from the center) of the light-emitting source 210, brightness of the light reaching the left eye zone is high. In other words, the light from the light-emitting portion 210a on the center side reaches an AL area, and the light from the light-emitting portion 210a adjacent thereto is emitted to an area which significantly overlaps the AL area, and hence the lights from the sequentially adjacent light-emitting portions 210a are emitted to the areas which sequentially overlap each other. Therefore, sufficient light is irradiated on the left eye zone.

Lights emitted from the left light-emitting portions 210b which are transmitted through the left area 212b of the polarizing filter 212 (a broken line indicates a center of the optical path) reach the Fresnel lens 203 where the directions of travel of the lights are changed, are passed through the micro-patterned retarder 204 and the liquid crystal display panel 205, and then reach the right eye zone.

Since the left light-emitting portions 210b are arranged consecutively on the center portion (left side from the center) of the light-emitting source 210, the brightness of the light reaching the right eye zone is high. In other words, the light from the light source 210b on the center side reaches the AR area, but the light from the adjacent light-emitting portion 210b is emitted to an area which significantly overlaps the AR area, and hence the lights from the sequentially adjacent light-emitting portions 210b are emitted to the areas which sequentially overlap each other. Therefore, the sufficient light is irradiated on the right eye zone.

The liquid crystal display panel 205 equalizes the pitch of the scanning lines of the liquid crystal display panel 205 and the repeating pitch of the polarization characteristics on the micro-patterned retarder 204, and the lights coming from the different directions are irradiated on each pitch of the scanning lines of the liquid crystal display panel 205 and hence the lights are emitted in the different directions.

Lights emitted from the right light-emitting portions 210a and passed through the right area 212a of the polarizing filter 212 pass through the Fresnel lens 203, reach the micro-patterned retarder 204, pass through the areas 204a of the micro-patterned retarder 204, where the polarization is turned by 90 degrees before emission (light transmitted through the right area 212a is transmitted), and then pass through the liquid crystal display panel 205, and reach the left eye zone. In other words, left-eye images displayed by the display devices at positions corresponding to the areas 204a of the liquid crystal display panel 205 reach the left eye.

Since the areas 204b which are arranged alternately with the areas 204a of the micro-patterned retarder 204 do not change the polarization of light, the lights from the right area 212a of the polarizing filter 212 do not pass through the polarizing plate 205a of the liquid crystal display panel 205, that is, the display devices (which display the right-eye images) at positions corresponding to the areas 204b of the liquid crystal display panel 205.

The lights emitted from the left light-emitting portions 210b and passed through the left area 212b of the polarizing filter 212 pass through the Fresnel lens 203, reach the micro-patterned retarder 204, pass through the areas 204b of the micro-patterned retarder 204 which allow the light of the same polarization as the left area 212b of the polarizing filter 212, pass through the liquid crystal display panel 205 and reach the right eye zone. In other words, the right-eye images displayed by the display devices at positions corresponding to the areas 204b of the liquid crystal display panel 205 reach the right eye.

Since the areas 204a arranged alternately with the areas 204b of the micro-patterned retarder 204 change the polarization of light, the lights from the left area 212b of the polarizing filter 212 do not pass through the display devices (which display the left-eye images) at positions corresponding to the polarizing plate 205a of the liquid crystal display panel 205, that is, the areas 204a of the liquid crystal display panel 205.

Although cross-talk caused by overlap of the right-eye image and the left-eye image due to birefringence or radio scattering on the Fresnel lens 203 or the liquid crystal display panel 205 may be generated, since the linear light-emitting source 210 is arranged in the lateral direction to cope with this problem, the cross-talk can be reduced.

As described above, the sufficient light is irradiated to the left eye zone and the right eye zone by the right light-emitting portion 210a and the left light-emitting portion 210b of the linear light-emitting source 210. In other words, the left-eye image having sufficient brightness reaches the left eye zone, while the right-eye image having sufficient brightness reaches the right eye zone. Therefore, even when the right-eye image enters the left eye, or the left-eye image enters the right eye due to the birefringence or radio scattering on the Fresnel lens 203 or the liquid crystal display panel 205, the difference in brightness from the left-eye image which reaches the left eye, or the difference in brightness from the right-eye image which reaches the right eye, relatively increases, and hence the cross-talk can be sufficiently eliminated.

Therefore, the viewer can easily recognize the three-dimensional image by the right-eye image and the left-eye image, and hence three-dimensional view can easily achieved by the three-dimensional perception based on the parallax of both eyes.

Lights from the light-emitting portions 210a disposed around the right periphery of the linear light-emitting source 210 are emitted to the left side of the left eye zone at a wide angle (DL area), and lights from the light-emitting portions 210b disposed on the left periphery of the linear light-emitting source 210 are emitted to the right side of the right eye zone at a wide angle (DR area).

Therefore, the viewing angle of the image display system increases. Therefore, when TV-game or the like is played with this image display system, or when this image display system is used as an image display system for displaying a game machine (such as a pinball machine), the image can be viewed not only by the player, but also many persons around the player.

Although the three-dimensional images cannot be seen in the DL area and the DR area, they can be seen as the two-dimensional images.

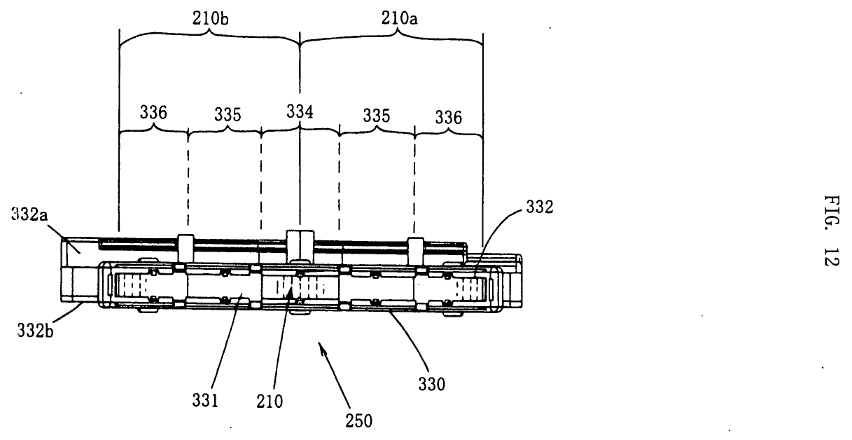

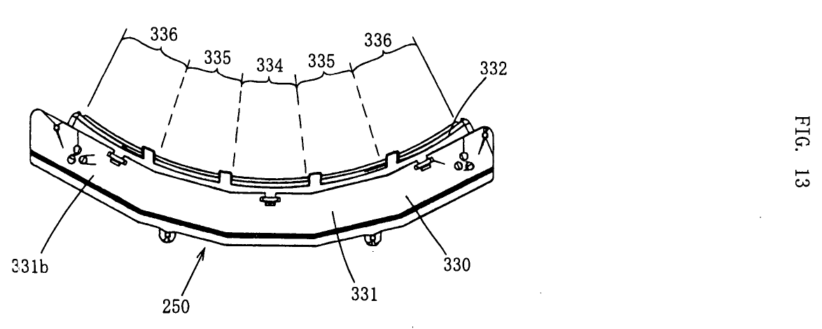

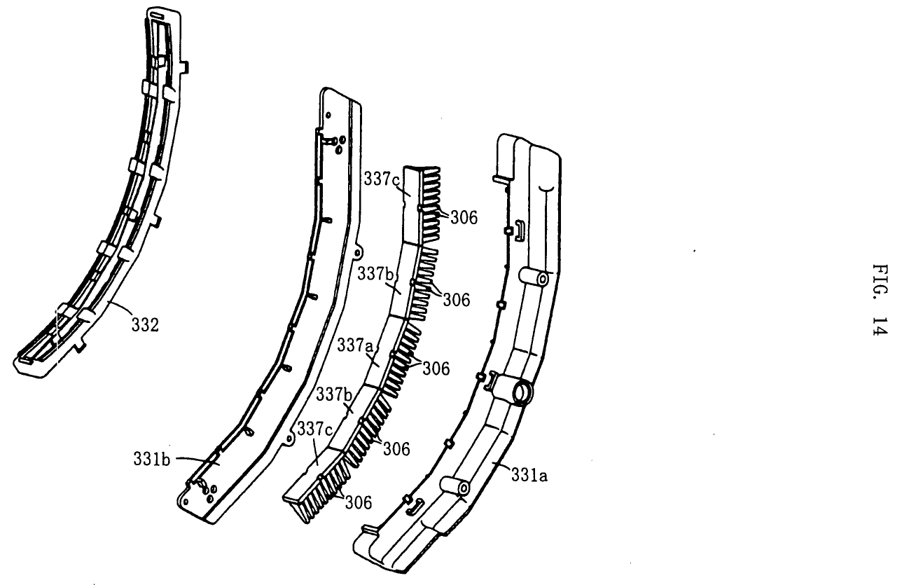

FIG. 12 to FIG. 14 are a plan view, a side view, and an exploded perspective view of the light source body unit 250 according to another embodiment. The linear light-emitting source 210 is composed of a plurality of linearly arranged point-like light-emitting sources (LEDs (light-emitting diodes): white light-emitting diode or the like) or elongated cold-cathode tube or the like. In this embodiment, a case in which the point-like light-emitting sources are employed will be described.

A holder 330 includes storage cases 332a, 332b and a cover 333 having divided structure forming a storage 331 into the shape of a polygonal line, and the storage 331 includes a center portion 334 of a predetermined length, intermediate portions 335 disposed on the both sides thereof so as to be inclined by a predetermined angle toward the front of the holder, and peripheral portions 336 disposed on the both sides thereof so as to be inclined by a predetermined angle toward the front of the holder.

The linear light-emitting source 210 includes a predetermined number of LEDs (light-emitting diodes: white light-emitting diode or the like) 305 which are linearly arranged and mounted to the substrate (not shown) at the center portion of a predetermined length, the intermediate portions disposed on the both sides thereof so as to incline by a predetermined angle toward the front of the substrate, and the peripheral portions disposed on the both sides thereof so as to incline by a predetermined angle toward the front of the substrate.

The prisms 306 for preventing diffusion of lights of the LEDs 305 and causing the lights to be emitted at a predetermined angle so that the centers of the optical axes passes the center portion of the Fresnel lens 203 are provided on the front surfaces of the LEDs 305. The prisms 306 are formed integrally with a center prism body 337a, intermediate prism bodies 337b, and peripheral prism bodies 337c respectively corresponding to center LEDs 305, intermediate LEDs 305, and peripheral LEDs 305.

The substrate on which the LEDs 305 are arranged is stored in the storage cases 332a, 332b of the holder 330, and the center prism body 337a, the intermediate prism bodies 337b, and the peripheral prism bodies 337c are aligned with and assembled to the LEDs 305 of the center portion, the LEDs 305 of the intermediate portions, and the LEDs 305 in the periphery thereof respectively, and the polarizing filter 212 (not shown) is mounted to the front surfaces of the respective prism bodies 337a, 337b, 337c via the cover 333, so that the light source body unit 250 is formed.

Although the linear light-emitting source 210 is formed into a single substrate, it is also possible to form the linear light-emitting source 210 by dividing the substrate into a linear center substrate, linear intermediate substrates and linear peripheral substrates, and arrange the LEDs 305 linearly on the respective substrates to form units respectively, and then arrange the plurality of linear light-emitting source units in the linear-shape into the shape of polygonal line.

In this arrangement, the linear light-emitting portions of the linear light-emitting source 210 can be arranged at a more uniform distance from the Fresnel lens 203 and at a distance closer to the focal distance thereof in comparison with the mode described above.

Therefore, unevenness of the brightness of the left eye zone and the right eye zone can be reduced sufficiently, and the three-dimensional image can be recognized further easily.

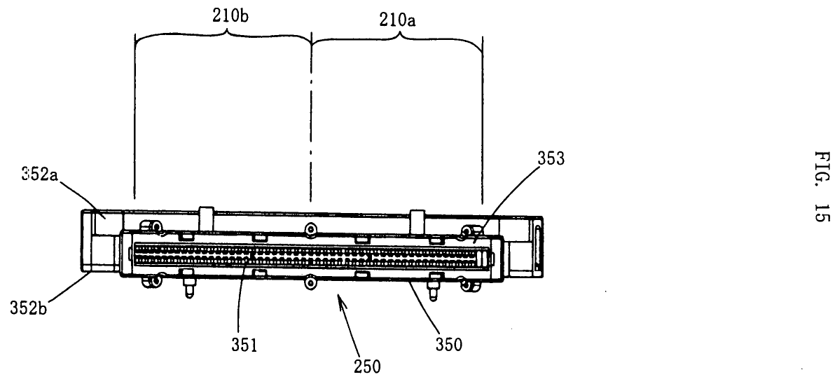

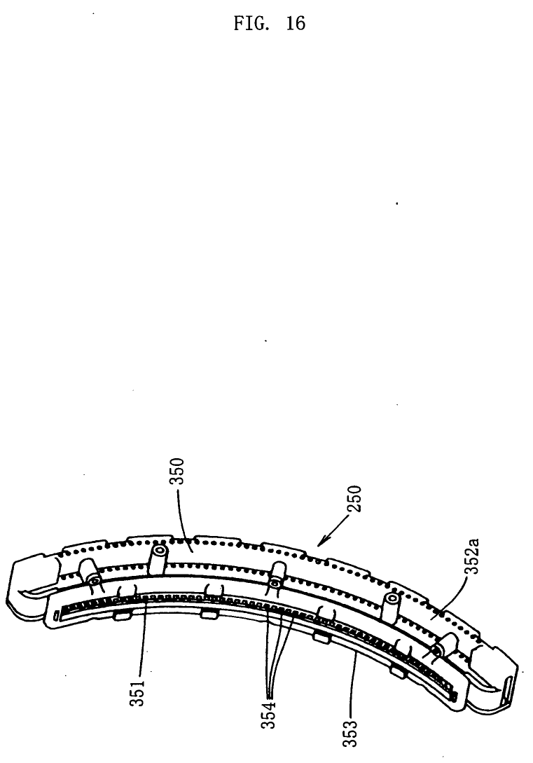

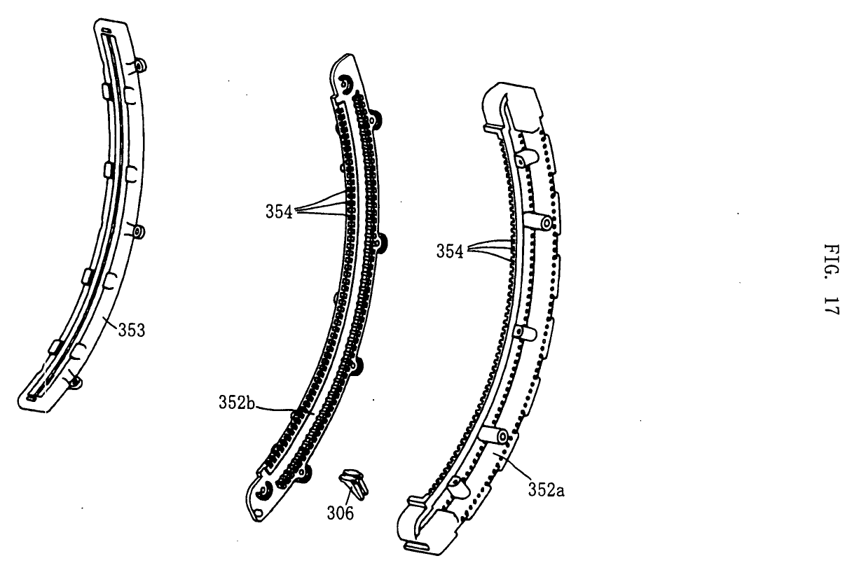

FIG. 15 to FIG. 17 are a plan view, a perspective view, and an exploded perspective view of the light source body unit 250 according to another embodiment. The linear light-emitting source 210 is formed of the plurality of point-like light-emitting sources arranged linearly (LEDs (light-emitting diodes): white light-emitting diode or the like) or an elongated cold cathode tube or the like, and in this embodiment, the case in which the point-like light-emitting sources are used will be described.

A holder 350 includes storage cases 352a, 352b and a cover 353 of separate members, and the storage cases 352a, 352b and the cover 353 form a storage 351 of an arcuate shape (shape of a curved line) of a predetermined curvature (the radius is equal to the focal distance of the Fresnel lens 203).

The linear light-emitting source 210 is formed by arranging and mounting a predetermined number of LEDs (light-emitting diode: white light-emitting diode or the like) 305 onto a substrate (not shown) formed by bending into an arcuate shape (shape of a curved line) of a predetermined curvature (the radius is equal to the focal distance of the Fresnel lens 203).

The prisms 306 for preventing diffusion of lights of the LEDs 305 and causing the lights to be emitted at a predetermined angle so that the centers of the optical axes pass the center portion of the Fresnel lens 203 are provided on the front surface of the LEDs 305.

The substrate on which the LEDs 305 are arranged is stored in the storage cases 352a, 352b of the holder 350, the prisms 306 are fitted to receiving grooves 354 formed at front edges of the storage cases 352a, 352b respectively to align with the LEDs 305. Then, the polarizing filter 212 (not sown) is mounted to the front surfaces of the respective prisms 306 via the cover 353, whereby the light source body unit 250 is formed.

Accordingly, the linear light-emitting portions of the linear light-emitting source 210 can be arranged at a uniform distance from the center of the Fresnel lens 203 and at a distance equal to the focal distance thereof in comparison with the respective modes described above.

Therefore, unevenness of brightness in the left eye zone and the right eye zone can be eliminated, whereby the three-dimensional image can be recognized further easily.

In the respective embodiments described above, the linear light-emitting sources 210 including the plurality of point-like light-emitting sources (LEDs (light-emitting diodes): white light-emitting diode and the like) arranged linearly thereon has been described. However, it is also possible to employ the cold cathode tube or the like, and in this case, the elongated cold cathode tube or the like may be formed into the shape of polygonal line or a predetermined arcuate shape (curved shape).

The embodiments disclosed here are shown as examples only, and are not intended to limit the invention. The scope of the present invention is not limited by the description shown above, but by claims, and is intended to include all the modifications having equivalent meanings to the claims without departing the scope of the invention.

1. An image display system comprising: a liquid crystal display panel which can transmit a light irradiated from behind; a light source for irradiating a light having a specific polarization and a light having a polarization orthogonal to the specific polarization onto the liquid crystal display panel; and a filter disposed between the liquid crystal display panel and the light source and having a first area for transmitting the light having the specific polarization and a second area for transmitting the light having the polarization orthogonal to the light having the specific polarization provided repeatedly in the vertical direction, the light source comprises a light-emitting source for emitting a light having unspecific polarization; polarizing means for turning the light having unspecific polarization into the form of the light having the specific polarization and the light having the polarization in which the polarization axis is orthogonal to the polarization axis of the specific polarization to output the lights, and optical means for refracting lights having different polarizations into the directions which is routed to left and right eyes respectively and irradiating the same on the liquid crystal display panel, wherein the light-emitting source is a linear light-emitting source for emitting light linearly, having a light source member for displaying three-dimensional images at a center portion thereof and light source members for enlarging the viewing angle at the both ends thereof, and the linear light-emitting source is disposed laterally with respect to the liquid crystal display panel and the linear light-emitting source is formed into the shape of a curved line so that light-emitting portions are positioned at substantially the same distance from a center portion of the optical means.

2. An image display system comprising: a liquid crystal display panel which can transmit a light irradiated from behind; a light source for irradiating a light having a specific polarization and a light having a polarization orthogonal to the specific polarization onto the liquid crystal display panel; and a filter disposed between the liquid crystal display panel and the light source and having a first area for transmitting the light having the specific polarization and a second area for transmitting the light having the polarization orthogonal to the light having the specific polarization provided repeatedly in the vertical direction, the light source includes a light-emitting source for emitting a light having unspecific polarization; polarizing means for turning the light having unspecific polarization into the form of the light having the specific polarization and the light having the polarization in which the polarization axis is orthogonal to the polarization axis of the specific polarization to output the lights; and optical means for refracting lights having different polarizations into the directions which is routed to left and right eyes respectively and irradiating the same on the liquid crystal display panel, wherein the light-emitting source is a linear light-emitting source for emitting light linearly, having a light source member for displaying three-dimensional images at a center portion thereof and light source members for enlarging the viewing angle at the both ends thereof, and the linear light-emitting source is disposed laterally with respect to the liquid crystal display panel and the linear light-emitting source is formed into a polygonal line so that light-emitting portions are positioned at substantially the same distance from a center portion of the optical means.

3. The image display system according to claim 1, characterized in that the linear light-emitting source has an arcuate shape centered on the center portion of the optical means.

4. The image display system according to claim 2, characterized in that the linear light-emitting source is formed in a shape of a symmetrical polygonal line having the linear light source member for displaying three-dimensional images extending in parallel with the display surface of the liquid crystal display panel at the center portion thereof, and the light source members forming an angle with respect to the display surface of the liquid crystal display panel for widening the lateral viewing angle at both ends thereof.

5. The image display system according to claim 2 or claim 4, characterized in that the linear light-emitting source in the shape of the polygonal line includes a plurality of units of the straight linear light-emitting sources disposed in the shape of the polygonal line.

6. The image display system according to any one of claim 1 to claim 5, characterized in that the linear light-emitting source includes a plurality of point-like light-emitting sources disposed linearly.

7. The image display system according to claim 6, characterized in that the plurality of point-like light-emitting sources include optical path correcting means for causing the respective centers of the optical axes pass through the center portion of the optical means between the point-like light-emitting sources and the polarizing means.
